(19) United States
(12) Patent Application Publication
(10) Pub. No.: US 2004/0148244 A1
(43) Pub. Date: Jul. 29, 2004

(54) System and method for consolidated order entry

(76) Inventors: Douglas Dauphinot Badeau, Hoboken, NJ (US); Todd Christopher Commisso, New York, NY (US); William Gebhardt, Montclair, NJ (US); Robert D. Lord, Middletown, NJ (US)

Correspondence Address: Leslie Gladstone Restaino, Esq., Brown Raysman Millstein Felder & Steiner LLP, 163 Madison Avenue, P.O. Box 1989, Morristown, NJ, 07962-1989, US

(21) Appl. No.: 10/352,641

(22) Filed: Jan. 27, 2003

(51) Int. Cl. G06F 17/60

(52) U.S. Cl. 705/37

(57) ABSTRACT

This invention provides methods and systems for facilitating trading of securities over a communications network. The methods and systems allow users to submit orders for trading securities with a consolidated order entry interface screen for single and multiple orders. The consolidated order interface screen provides the user with a single order entry point for submitting orders to trade securities of different types. The consolidated order interface screen, in one embodiment, provides the user with a centralized order entry point for a plurality of security trading platforms. Each of the plurality of security trading platforms may processes orders for given types of a securities, for particular types of security orders, or for particular types of users. Orders to trade securities are tested to determine if they are valid or otherwise capable of being executed. Testing may include determining whether syntax edits are required and whether business edits are required. Testing for business edits may further include determining whether the orders required soft or hard edits and associating a status thereto which may be accounted for prior to posting. Moreover, users may determine the availability of a security for a short sale by interfacing with a share availability warehouse.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

The invention generally relates to securities trading. Specifically, the invention discussed herein relates to methods and systems for facilitating trading of various types of securities over a communications network using a client based user interface.

Client based securities trading is generally available to individual investors by online trading firms. To post securities trade orders using currently available services, users must typically navigate to a general trading page, which permits further navigation to pages specifically designated for trading particular types of securities, such as stocks, bonds, mutual funds, etc. Users may post orders to execute trades in the particular security, e.g., a stock, by navigating from the pages specifically designated for trading the particular type securities, e.g., stock trading pages, to a trading page for placing the order for the particular security, e.g., a stock order page. The process must typically, however, be repeated for each type of security for which orders are being posted. For example, one interested in trading stocks and bonds must first navigate to the general trading page, followed by the pages designated for trading stocks, then to a stock order page in which the details of the order are specified. The process must then be repeated for the bonds.

Financial professionals, such as financial analysts, brokers, dealers, etc., do not generally use the on-line trading interfaces such as those available to individual investors; rather, financial professionals use specialized and proprietary securities trading platforms. There are currently a number of securities trading platforms that provide specialized services, e.g., limited to specific types of securities, specific types of trades, e.g., short sales, and/or types of financial professionals, and proprietary trading services to financial professionals. Because features of certain platforms are limited and/or proprietary, such features do not appear in more than one platform, thereby requiring access to multiple platforms for trading different types of securities and/or using different features. Each platform typically requires a workstation connected over a private network to the trading platform provide, thus requiring specialized equipment to make multiple platforms available on a single workstation. Consequently, trading with multiple platforms entails logging on to each service and navigating through the interfaces provided therein to place each order to trade a security. Moreover, orders placed over certain platforms are typically followed by manual procedures, such as documenting short sales on a third financial system with a trading ticket.

Client based online trading systems for individual investors and those employed by financial professionals possess numerous shortcomings, including, among other things, the need for the user to navigate through a plurality interfaces and through different trading platforms to enter orders for different types of securities. Thus, there is a need for systems and methods that reduce the requirements necessary to place orders for different types of securities.

### SUMMARY OF THE INVENTION

In accordance with this invention, systems and methods are providing for facilitating trading of securities over a communications network. Securities is used herein to denote any type of financial instrument that may be traded, including but not limited to notes, stocks, treasury stocks, futures, bonds, debentures, certificate of interest, commodities, certificate of deposits, contracts, etc.

In one aspect of this invention, securities trading may be facilitated by providing systems and methods allowing users to submit orders for trading securities via a client device connected to at least one server over a communication network. The server in response to a navigation request displays or causes to be displayed a consolidated order entry interface screen. The consolidated order interface screen provides the user with a single order entry point for the user to submit orders for securities of different types. The consolidated order interface screen, in one embodiment, provides the user with a centralized order entry point for a plurality of security trading platforms. Each of the plurality of security trading platforms may processes orders for given types of a securities, for particular types of security orders, or for particular types of users.

In another aspect, methods and systems are provided for displaying a multiple order consolidated order entry interface screen in response to a user navigation request. In multiple order consolidated order entry interface screen provides the user with a single order entry point to submit a plurality of orders for securities of different types in one transaction. In one embodiment, the multiple order consolidated order entry interface screen provides the user with a centralized order entry point for a plurality of security trading platforms.

The navigation requests may be generated from an interface screen integrated with the consolidated order entry interface screen from which the consolidated order entry interfaces screen is fed and displays relevant form elements filled in. Orders to trade securities received by the system are tested to determine if they are valid or otherwise capable of being executed. Testing may be accomplished in a variety of ways. Testing may be accomplished by determining syntax edits are required, such as by determining whether the orders contain the requisite information for execution and determining whether the information specified by the user is in a proper format. Testing may also be accomplished by determining if business edits are required. Testing for business edits, in one embodiment, comprises determining whether the orders satisfy business rules, which define the obligations and limitations for the user.

In another aspect, this invention provides methods and systems for determining if soft and hard edits are required. A soft edit status may be associated with orders requiring soft edits and a hard edit status associated with orders requiring hard edits. The soft/hard edit association may be accounted for in recap interface screen in which the status of each order may be displayed therein. Users may edit or cancel the soft and hard edit orders. Soft edit orders are capable of being posted without being amended whereas hard edit orders are cancelled when the orders are submitted for confirmation.

According to other embodiments, the invention provides methods and systems that allow users to determine the availability of a particular security within a share availability warehouse for a short sale. The determination is preferably made with a short sale authorization interface screen, which includes at least one form element for specifying security information for which availability will be determined and a conversation form element which enables conversation type messaging between the user and the share availability warehouse.

### BRIEF DESCRIPTION OF THE FIGURES

The invention is illustrated in the figures of the accompanying drawings which are meant to be exemplary and not limiting, in which like references refer to like or corresponding parts, and in which:

FIG. 1 is a block diagram of a system for providing consolidated order entry for trades according to one embodiment of the invention;

FIG. 2 is a flow diagram of a method for providing consolidated order entry for trades according to one embodiment of the invention;

FIG. 3 is a flow diagram of a process for handling errors in orders for trades according to one embodiment of the invention; and

FIGS. 4, 5, and 6 are screen diagrams of user interfaces useful in implementing consolidated order entry according to one embodiment of the invention.

### DETAILED DESCRIPTION OF PREFERRED EMBODIMENTS

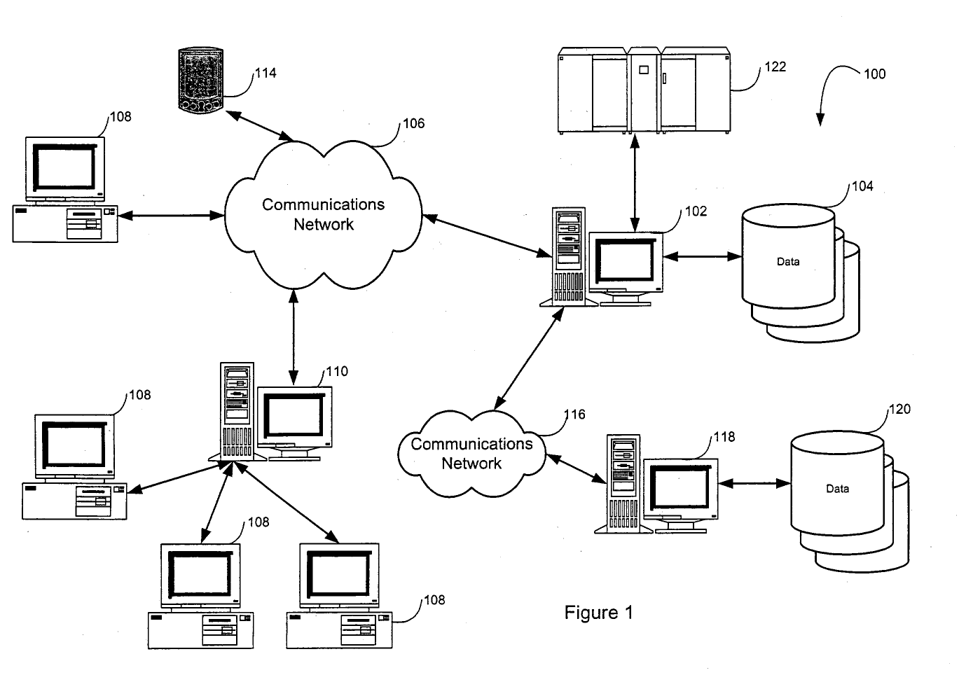

Referring to FIG. 1, a system 100 for providing consolidated order entry (COE) for security trades according to one embodiment of the invention includes at least one COE server 102, having at least one database 104, connected to at least one client device, e.g., 108, by a communications network 106. Providers of financial services may maintain and offer access to the COE server 102 to thereby provide the functionality of the invention described herein to end users. The client devices may be used by individual investors, financial advisors, traders brokers, dealers, institutional investors, etc. to access the COE service 100. The communications network 106 is any suitable communications link, such as a local area network (LAN), wide area network (WAN), the Internet, etc., a wireless network, or any combinations thereof. The client devices 108 may optionally be connected to the COE server 102 via a proxy server 110. A client device is generally a multipurpose computer having a processor and memory that is capable of communicating with the COE server 102 and also capable of displaying information received therefrom. A client device may therefore be a personal computer (PCs), special purpose computer, a workstation, a wireless device 114, such as personal digital assistants (PDA), cellular phones, two-way pagers, etc.

In some embodiments, the COE server 102 is connected to a mainframe computer 122 and/or at least one application server 118 having at least one database 120 associated therewith. The mainframe computer 122 and/or the application server 118, either alone or in combination, provides application programming logic that provides the backend functionality of the invention. In at least one embodiment, the COE server 102 is connected to at least one application server 118 via a private communication network 116, such as a LAN or WAN. The servers and/or mainframe computer include at least one program application or program module for processing orders to trade securities. Preferably, the servers 118 and/or mainframe computer 122 include programming for a plurality of order-trading platforms, each platform capable of processing orders for particular types of securities, particular types of orders to trade security, and/or for particular types of users. For example a first platform may be capable of processing orders to trade stocks, a second platform processes orders for stock options, a third to process futures orders, a forth to process after hours orders, etc. Similarly, a first platform may be used to process long sales, a second to process short sales, etc. Further, a first platform may process orders from individual investors, a second processes orders from financial professionals, a third processes orders from institutional investors, etc.

The COE server 102, application server 118, and/or the mainframe computer 122, alone or in combination, include programming for providing users with consolidated order entry point for security trades. Consolidated order entry generally refers to providing a centralized order entry point for all trade orders regardless of the type of security, the type of order, or the type of user. In one embodiment, where security orders are processed on a plurality of order entry platforms, consolidated order entry provides a centralized order entry point for all security order platforms. Thus, if each of a plurality of security order platforms processes particular types of securities, consolidated order entry provides a single order entry point for trade orders for different types of securities.

Where each platform processes orders for particular types of orders or for particular types of users, consolidated order entry provides a centralized order entry point for different types of trade orders and for different types of users. In another embodiment, consolidated order entry provides a centralized order entry point for a plurality of order entry platforms and support systems, such as ConsultWorks, ConsultNet, PWOS, Client and Consolidated Services (CSC), Edge, Online Trading (OLT), Broker Order Entry (BOE), SOF, Continued Trade Processing System/UBS Brass (CTPS), Direct Order Routing System (DORS), SmartLoan/CIGMA, etc. In one embodiment, consolidated order entry is provided with straight through order processing. Straight though order processing refers to the processing of orders to trade securities in a streamlined automated process that eliminates otherwise duplicative manual steps in processing orders to trade securities, such as, with regard to financial professionals, eliminating the need for the user/professional to fill out order tickets, etc.

Client devices 108 and 114 preferably include programming therein, such as an Internet or Web browser application, for displaying a plurality of graphic user interface screens and for allowing users to communicate trades to the COE system, particularly to the COE server 102. The COE server 102 and in some embodiments, the applications server 118, and/or mainframe computer 122, are associated with a database or databases populated with user and financial information. User information includes data for each particular user, such as a user name, identification number, password, a user profile indicating whether the user is an individual investor, a financial professional, such as a financial advisor or trader, entitlement information, if the user is a financial professional, data regarding clients, account balances, positions, pending orders, etc. Financial information includes, symbols associated with particular securities, pricing data, historic data, etc., which information may be provided to users in real-time where applicable.

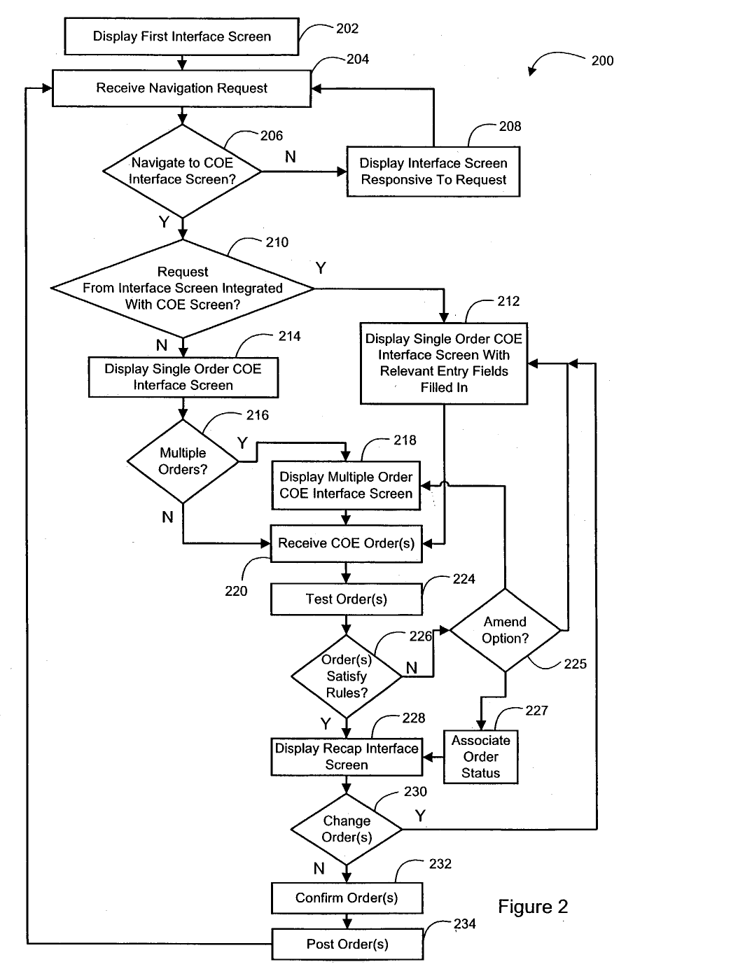

Referring to FIG. 2, a method for providing consolidated order entry for security trades, as introduced in FIG. 1 is presented. The method begins, step 202, by displaying or causing to be displayed a first interface screen. The first interface screen is preferably displayed automatically when the user establishes communication with the system. Establishing communication with the system, in one embodiment, entails the user executing programming, such as an Internet or Web browser application, at the client device, such as by clicking an icon, hyperlink, etc. with a computer input device, such as a mouse, track ball, touch pad, keyboard, etc. and/or by specifying an Internet protocol (IP) or web address associated with the service provider.

The first interface screen may be, for example, a web page, such as the service provider's home page, login page, etc. In one embodiment, the first interface screen includes therein form elements, such as input fields, which allow users to submit information identifying the user, such as a user name and password. The first interface screen also includes therein elements, such as hyperlinks, action buttons, clickable images, etc., which allow users to navigate to other interface screens, such as interface screens providing general information regarding securities, markets, and/or interface screens providing information regarding user data, such as account information, portfolio information, stock records, unrealized gains and losses, etc.

According to one embodiment, the first interface screen includes therein at least one element enabling users to navigate to a COE interface screen, which provides users with consolidated order entry. The COE interface screen provides a centralized order entry point for different types of orders, such as orders to trade stocks, bonds, contracts, futures, warrants, commodities, currencies, debenture, certificates of deposit, etc., for different types of security orders, for different types of users, and/or for a plurality of security order platforms. Moreover, use of the COE interface screen by financial professionals, such as financial advisors, eliminates duplicative manual steps in processing orders to trade securities, such as order tickets.

Upon the user selecting or clicking an element in the first interface screen in order to navigate to a subsequent interface screen, a navigation request is issued to the system, step 204. If the request prompts the system to display or cause to be displayed an interface screen at the client device other than a COE interface screen, step 206, the system displays or causes to be displayed an interface screen responsive to the navigation request, step 208. For example, an interface screen containing general information regarding a particular security or securities or an interface screen containing user data, such as account information, portfolio information, stock records, unrealized gains and losses, etc. The subsequent interface screens preferably include therein at least one element, which allow users to navigate to subsequent interface screens therefrom, including a COE interface screen. The user may then submit subsequent navigation requests for which the steps 204, 206, and 208 will be repeated for each subsequent navigation request received.

If the user requests that the system display or cause to be displayed a COE interface screen, step 206, the system determines if the request was generated from an interface screen that is integrated with and thereby feeds data to the COE interface screen, step 210. An integrated interface screen is generally one in which information displayed or contained therein is relevant to and may be included in the COE interface screen. For example, an interface screen that displays information regarding a particular security, such as a stock, typically includes the security trading symbol, the last sale price, bidding and asking prices, etc., thus navigating from such an interface screen may feed data, such as the security trading symbol, a price, etc., to the COE interface screen. Similarly, information regarding an security held in a user portfolio typically includes the security trading symbol, the quantity held, the purchase price, whether the security is held in a short or long position, etc., thus navigating from such an interface screen may feed to the COE interface screen the security trading symbol, an order type, e.g. sell securities held in long positions, buy to cover securities held in short positions, etc.

Thus, if the request is generated from an integrated interface screen, step 210, a single order COE interface screen is displayed or caused to be displayed at step 212 at the client device with relevant form elements, e.g., data entry fields, filled in. The user may accept the relevant data fed to the COE interface screen or change one or all of the fields accordingly before submitting the order or orders for security trades. If the navigation request was not generated from an integrated interface screen, step 210, a single order COE interface screen is presented to the user, step 214.

In one embodiment, the single order COE interface screen includes therein an element, such as a hyperlink, action button, clickable image, etc., which allows the user to indicate a desire to enter a plurality of security trade orders. If a user indicates such a desire to enter a plurality of orders, step 216, the system displays or causes to be displayed a multiple order COE interface screen with which the user may submit or post a plurality of orders, step 218. A plurality of orders for different types of securities and different types of orders may be submitted with the multiple order COE interface screen, for example, a plurality of trades comprising orders to buy or sell stocks, bonds, contracts, futures, warrants, commodities, currencies, market, limit, after hours trades, etc. The multiple order COE interface screen preferably allows users to submit multiple security orders in one transaction.

Orders placed though either the single order COE interface screens, steps 212 or 214, or the multiple order COE interface screen, step 218, are received by the system, step 220. The orders are tested prior to posting for execution, step 224. Testing generally includes the necessary steps to ensure the security orders are valid or otherwise capable of execution based on rules or criteria, such as on rules relating to syntax, business rules, rules promulgated to comply with regulations governing the trade in securities, etc. If individual orders do not satisfy the relevant rules or criteria for execution, step 226, the user is given an opportunity amend or cancel the failed orders.

The opportunity to amend or cancel the failed order may be accomplished in a variety of ways. A determination may be made as to which method to apply in allowing a user to amend failed orders, step 225. In one embodiment, a single order COE interface screen, preferably with the relevant fields filled in, is displayed for the order not satisfying the rules or criteria. Steps 212, 220, 224, and 226 are repeated for the order resubmitted by the user. Users may amend unsatisfactory orders accordingly to comply with the rules or criteria for execution prior to resubmission, or cancel the failed order. Alternatively, where a plurality of orders fail to satisfy the rules or criteria for execution, a multiple order COE interface screen is displayed, preferably with relevant fields filled in, allowing the user to amend or cancel each or all the orders contained therein. In a third embodiment, the system associates a status as either pass or fail to each order at step 227 and the status is accounted for accordingly prior to posting submitted orders.

Submitted orders and the details thereof are recapped to the user, such as by displaying or causing to be displayed a recap interface screen, step 228. The recap interface screen may include form elements, such as input fields, requiring the user to enter a user password. The recap interface also includes elements, such as hyperlinks, buttons, etc., for the user to confirm, amend, and/or cancel submitted orders displayed therein. In one embodiment, particular orders that have not satisfied the rules or criteria for execution are indicated as such, e.g., by highlighting unsatisfactory orders, specifying the status as pass or fail, etc. thereby prompting the user to take further action with regard to the unsatisfactory order.

If the user desires to amend orders that appear in the recap interface screen, step 230, the user may do so by selecting or clicking one of the plurality of links presented in the recap interface screen in which steps 212, 220, 224, 226, 228, and 330 are repeated for each order selected to be amended, or steps 218, 220, 224, 226, 228, and 230 are repeated in the instance that a plurality of orders are to be amended. The single COE interface screen displayed or caused to be displayed at step 212 and the multiple COE order interface screen displayed or caused to be displayed at step 218 are preferably provided with the fields filled in and the offending elements highlighted or otherwise indicated as such so that the user may, if possible, amend the elements accordingly.

In one embodiment, orders to short sell securities may be amended with the aid of an interactive short sale authorization interface screen, which allows users to interactively communicate with a share availability warehouse, such as CIGNA, owned by Sunguard Systems, to determine the availability of a particular security for a short sale. Interactive generally refers to conversational type messaging, which allows users to communicate back and forth with the share availability warehouse. The interactive short sale authorization interface screen includes a plurality of form elements that allow the user to communicate with a share availability warehouse to determine the availability of a particular security. The interactive short sale authorization screen also aids the user in editing the short sale in order to satisfy applicable rules and criteria for execution. In one embodiment, users may access the short sale authorization interface screen to determine availability of a security for a short sale prior to placing an order to short sell the security.

If the user does not desire to make changes to the orders displayed in the recap interface screen, step 230, the user may submit orders for posting by selecting or clicking the appropriate elements provided therein, such as by selecting a “Submit” button. Orders that satisfy the rules or criteria for execution are thereby confirmed, step 232, and a confirmation number is presented or caused to be displayed to the user, preferably with a listing of the confirmed orders and the details thereof. Orders that did not satisfy the rules or criteria for execution are preferably automatically cancelled. Confirmed orders are posted for execution, step 234.

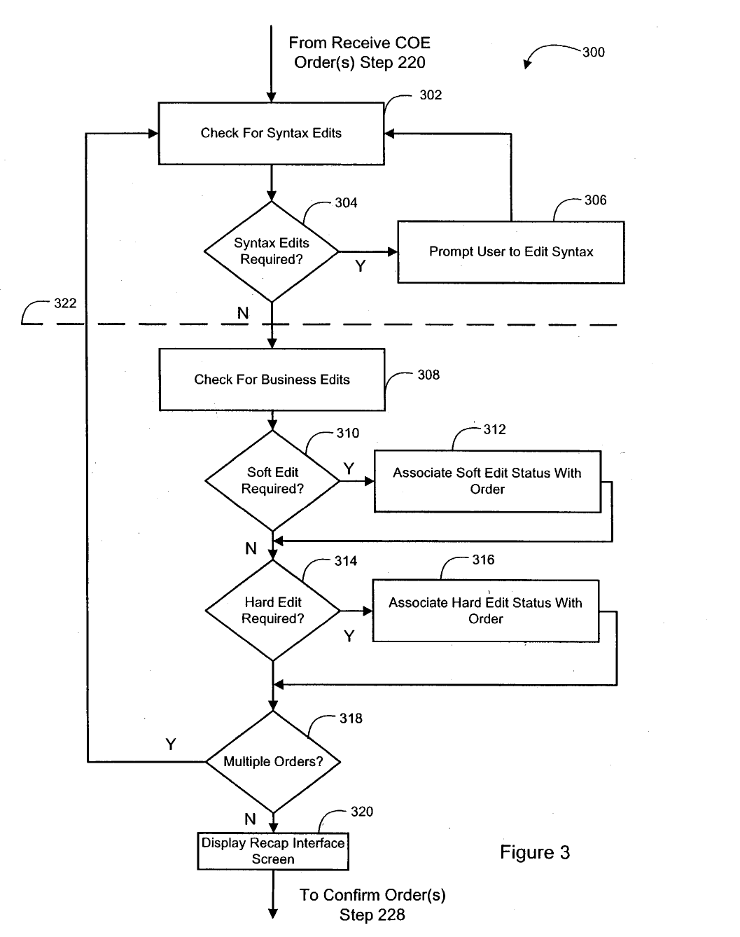

Referring to FIG. 3, a process is presented for handling errors in orders for security trades. According to one embodiment of the invention, the process is carried out in two-steps: checking orders for syntax edits, step 302, and checking orders for business edits, step 308. In one embodiment, the two-step process is handled separately as shown by dividing line 322. Syntax edit checking is preferably performed at the client device, whereas business edit checking is performed by the portion of the system providing the backend functionality, such as by a COE server, an application server, a mainframe computer, or a combination thereof.

Checking for syntax edits, step 302, generally entails determining whether the received orders to trade securities contain the requisite information from the user in the proper format to post and process the orders. Syntax edit checking may therefore include a determination of whether the required fields have been filled in and whether the user provided the correct types of characters, e.g., alpha or numeric, or both, the correct format, e.g., date, time, identification number, currency, etc. Further, syntax edit checking may include determining whether particular fields are compatible. For example, where particular types of orders, e.g., short sales, must be specified in connection with a particular type of account, e.g., a Type 4 account, a syntax edit will be required in instances where the order type does not match the account type. If syntax edits are required, step 304, the user is prompted to amend the order or provide the requisite information accordingly, step 306.

If syntax edits are not required, step 304, the orders are checked for business edits, step 308. Business edit checking, step 308, generally entails determining whether the received orders satisfy business rules, rules promulgated to comply with regulations governing the trade in securities, etc. Business rules generally take into account the contractual obligations and limitations for a particular user, for example, whether there are sufficient funds in the user account, including cash and margin accounts, whether the particular user is authorized to submit the particular type of order, such as non-covered positions in options contracts, whether the specified orders are a valid combination, etc. An exemplary set of combinations is provided in Table A wherein “X” indicates a valid combination and Edit indicates the order may require amendment, etc. Definitions for the acronyms provided in Table A appear in Appendixes A and B, attached hereto.

TABLE A

| | Duration | | | | | Qualifiers | | | | | |
|---|---|---|---|---|---|---|---|---|---|---|---|
| | Day | GTC | GTX | IOC | FOK | OB | AON | DNR | DNI | AON/DNI | AON/DNR |
| Market | X | Edit | Edit | Edit | Edit | Edit | Edit | Edit | Edit | Edit | Edit |
| Limit | X | X | X | X | X | | X | X | X | X | X |
| Stop | X | X | | Edit | Edit | | Edit | X | X | Edit | Edit |
| Stop/Limit | X | X | | Edit | Edit | | Edit | X | X | Edit | Edit |

Business edits may be categorized as either soft business edits or hard business edits. If a soft business edit condition exits, the user is prompted that condition exists and is provided an opportunity to either enter, amend, or cancel the particular order. If a hard edit conditions exists, the particular order is blocked and the user is prompted to either amend or cancel the order. Hard edit conditions exist if, for example, the user account has insufficient funds to cover the order or if the user is not authorized to submit a particular type of order. Similarly, a hard edit condition exists for orders to short sell securities if the security, through a share availability warehouse, is not available or if the availability is limited. A listing of exemplary hard edit conditions is presented in Appendix A attached hereto.

The soft/hard edit condition prompt is provided by associating a status with each order. Thus, if a soft edit is required for an order, step 310, a soft edit status is associated with the order, step 312. Where a hard edit is required, step 314, a hard edit status is associated with the order, step 316. An order not associated as either soft or hard order status is categorized as having passed.

When multiple orders have been received, steps 302, 304, 306, 308, 310, 312, 314, and 316 are repeated accordingly for each order. Once the last order is tested, the recap interface screen is displayed, step 320. The recap interface screen preferably includes a status column with which an order status will be displayed for each order. A “Pass” status may be used to denote orders that satisfy the soft and hard edit rules, which orders may be confirmed and posted without requiring further amending or editing. Orders that do not satisfy the soft edit rules and satisfy hard edit rules may be denoted with a “Pass/Edit” status. In one embodiment, the “Pass/Edit” will be a hyperlink allowing a user to click or select the status, and view, accept, edit, or cancel the offending order. In some embodiments, the user is required to enter a password at the recap interface screen in order to post orders for execution with a “Pass” or “Pass/Edit” status. Orders that do not satisfy the hard edit rules are denoted with a “Fail” status. Similarly, the “Fail” may be a hyperlink allowing a user to click or select the status, and view, edit or cancel the offending order. Failed orders will not be posted for execution.

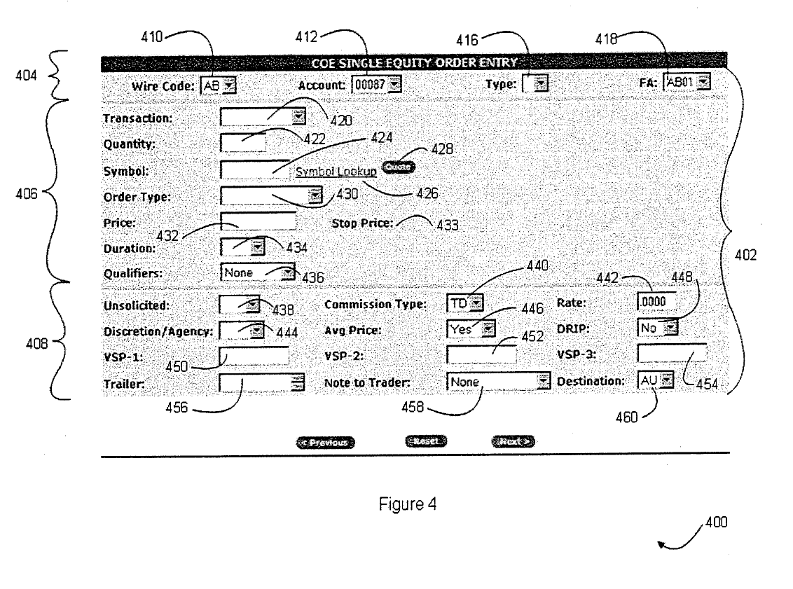

A single order COE interface screen is presented in FIG. 4. According to one embodiment, the screen includes a plurality of form elements, such as input fields, drop down lists, check boxes, radio buttons, password fields, action buttons, clickable images, etc. The single order COE interface screen preferably includes an account information request area 404, which includes at least one form element that may be used to specify user specific data, such as a wire code 410, account number 412, account type 416, financial advisor (FA) number 418 when applicable, etc.

The COE interface screen also comprises a security information request area 406, which includes at least one form element that may be used to specify data necessary for posting an order to trade a particular security, such as the type of transaction 420, the quantity 422, the symbol 424, the order type 430, the order price 432, a stop price 433 if applicable, the duration of the order 434, qualifiers 436, etc. The COE interface screen may also include a financial professional data request area 408, which may be used by financial professionals, such as financial analysts, traders, etc., to specify order handling details for an orders, such as whether the order was solicited 438, the type of commission 440, the rate of commission 442, whether the account is a discretion account 444, whether average pricing applies 446, whether the order is associated with a dividend reinvestment plan (DRIP) 448, optional versus purchase (VSP) elements 450, 452, and 454, a trailer element 456, a note to trader 458, and a destination 460.

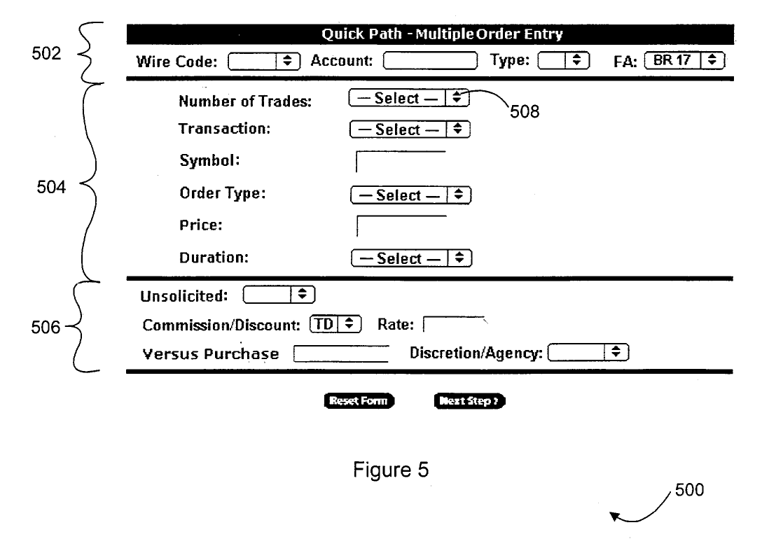

Turning to FIG. 5, a multiple order COE interface screen is illustrated. The multiple order COE interface, includes a plurality of form elements for the user to specify user specific data 504, data necessary to post orders to trade a plurality of particular securities 504, and optionally, for financial professionals to specify order handling details of the plurality of orders 506. The interface further includes a form element, such as an input filed or a drop down list, for specifying the number of trades to be submitted 508 and a plurality of form elements for specifying the details thereof 502. The form elements may be left blank in the multiple order COE interface screen whereupon the user will have to specify the required data for each order in subsequent interface screens.

Data provided in the multiple order COE interface screen is preferably fed to and fills in the corresponding data for each order in subsequent interface screens. For example, the user may specify an account number in the multiple order COE interface screen and the account number will be fed to and will fill in the corresponding account number field for each order. This feature is particularly useful for the user to provide data for a plurality of orders for the same account, type of account, type of transaction, security, type of order, price, duration, solicitation information, commission/discount, commission rate, versus purchase (VSP), and discretion/agency.

In one embodiment, the rate of the commission is computed with a user specified commission rule. The user specified commission rules may be saved and updated by the user, and applied in connection with the single order and multiple order interface screens. Additionally, the user specified rules may be applied in connection with a commission calculator interface screen, which enables the user to calculate commissions for a plurality of orders. The commission interface screen optionally provides real time stacking of trades in regard to commissions. Exemplary syntax requirements and the types of entries that may be specified by the user for each of the fields shown in FIGS. 4 and 5 are provided in Appendix B, which is attached hereto.

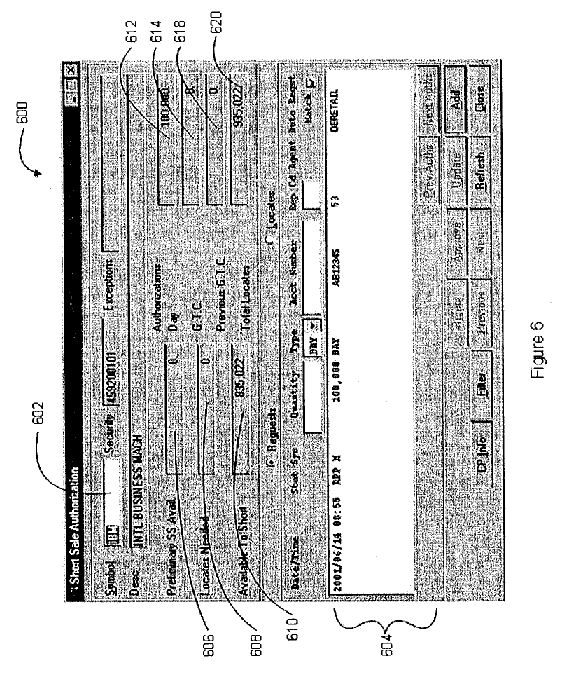

A short sale authorization interface screen that a user may use to communicate with a share availability warehouse to determine the availability of a security for a short sale is shown in FIG. 6. The short sale authorization interface screen, 600, includes at least one form element for the user to specify security information to determine availability, such as a symbol 602, and a conversation element, 604, which enables conversation type messaging between the user and the share availability warehouse. The interface further includes a plurality of text areas that provide availability information, such as Preliminary SS Availability 606, Locates Needed 608, Available To Short 610, Total Locates 620, Day 612, as well as G.T.C. 614 and Previous G.T.C. 616 Authorizations. Preliminary SS Availability refers to shares that are currently available within the share availability warehouse. If the Preliminary SS Availability is either equal to zero or less than the number of shares to be traded, the user may look to a second field to determine share availability. Available to Short refers to the number of institutional shares available that can be secured.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

### Appendix A

Quantity Definitions

Odd Lot—Any purchase or sale of less than 100 shares

Round Lot—Any purchase or sale of shares in multiples of 100 shares.

Mixed Lot—A mixed lot is a purchase or sales of shares that include a round lot, e.g., (multiple of 100) plus an odd lot (1-99 shares).

Hard Edit Conditions and Business Rules

Cancel & Replace Restrictions (CXL & RPL)

Hard Edit—Cannot CXL & RPL from round lot to odd lot.

Hard Edit—Cannot Partial Cancel from round lot to odd lot

Hard Edit—Cannot Partial Cancel an OTC stock

Do Not Reduce & Do Not Increase (DNR/DNI)

Hard Edit—Cannot place Do Not Reduce (DNR) order with an odd lot.

Hard Edit—Cannot place Do Not Increase (DNI) order with an odd lot.

Hard Edit—Buy Stop/Do Not Reduce (DNR)

Hard Edit—Sell Limit/Do Not Reduce (DNR)

Hard Edit—Buy Stop/Do Not Increase (DNI)

Hard Edit—Sell Limit/Do Not Increase (DNI)

Hard Edit—OTC Mixed Lot STP GTC/DNR (Remove)

Hard Edit—OTC Mixed Lot STP GTC/DNI (Remove)

No Edit—OTC Mixed Lot STPLMT GTC/DNR

All or None (AON)

Hard Edit—Cannot place All or None order with an odd lot.

Hard Edit—Cannot place AON on a 100 share order

Hard Edit—Cannot place AON order on less than 200 shares.

Hard Edit—FOK & AON simultaneous order instruction

Hard Edit—IOC & AON simultaneous order instruction

Hard Edit—OTC Mixed Lot GTC/AON (Remove)

No Edit—OTC Mixed Lot GTC/AON DNR

No Edit—OTC Mixed Lot GTC/AON DNI (Change/Invalid Trade)

Fill or Kill (FOK)

Hard Edit—Fill or Kill is not permitted with an odd lot.

Hard Edit—Fill or Kill is not permitted with a market order. (5/00 addition to edit list)

Hard Edit—Fill or Kill is not permitted with mixed lot orders.

Hard Edit—Fill or Kill is not permitted during non-market hours.

Immediate or Cancel (IOC)

Hard Edit—Immediate or Cancel is not permitted with mixed lot orders.

Hard Edit—Immediate or Cancel is not permitted with a market order.

Hard Edit—Immediate or Cancel is not permitted with an odd lot.

Hard Edit—Immediate or Cancel is not permitted during non-market hours

Stop Orders (STP)

Hard Edit—OTC Odd Lot STPLMT GTC (remove)

Hard Edit—STP/AON combination (Stop Limits can use AON)

Hard Edit—OTC Small Cap/STP combination

Hard Edit—OTC Bulletin Board/STP combination

Good Till Cancel (GTX)

Hard Edit—Odd lot/GTX combinations

Hard Edit—OTC/GTX combinations. Exchange listed stocks only.

Hard Edit—Securities order instruction only.

Hard Edit—A GTX order cannot be straight cancelled between the hours of 4:15 & 5:00 EST

Market on Close (CLO)

Hard Edit—Odd lot/Market on Open combination.

Hard Edit—OTC/Market on Close combination.

Hard Edit—Market on Close order must be entered prior to 3:50 EST. On option expiration Friday, Market on Close order must be entered prior to 3:40 EST.

Hard Edit—Any MOC orders entered on option expiration cannot be cancelled after 3:40 EST.

A “Market on Close” order instruction is valid for exchange traded securities and options.

A “Market on Close” order becomes active in the last two minutes of trading.

Market on Open (OPEN)

Hard Edit—Odd lot/Market on Open combination.

Hard Edit—OTC/Market on Open. For exchange listed stocks only.

If security does not reach the specialist post on time, all “Market on Open” orders are cancelled out.

If the security is delayed or halted, all OPG orders are not cancelled.

This order will only be executed if it is part of the first actual trade of the day. If it is not part of the opening trade, the order is automatically cancelled.

Or Better (OB)

Hard Edit—Odd lot/Or Better combination

GTX Orders (GTX)

Hard Edit—Odd Lot/GTX combination

Hard Edit—OTC/GTX combination.

Short Sales

Hard Edit—Must be placed on 100 shares or more. No odd lots.

Hard Edit—Short Sale/Bulletin Board security.

Buy to Cover (BTC)

Hard Edit—If the BTC share quantity is greater than the type 4 short position.

Hard Edit—If the user places a BTC trade on a security with a zero position in the type 4 short account.

Short Sale Error Handling

SHORT SALES—SHARES NOT AVAILABLE

Hard Edit—The user is entering a Short Sale transaction in which the total number of available shares is less than or equal to 0.

SHORT SALES—PARTIAL SHARES AVAILABLE

Hard Edit—The user is entering a Short Sale transaction in which the quantity of the transaction is greater than the total number of shares available to short. The total number of available shares is greater than 0.

SHORT SALES—SECURITIES BELOW $5.00

Hard Edit—Any security OTC Bulletin board and any other securities the firm deems PCG FA's are unable to sell short.

SHORT SALES—UPC-71 SECURITIES

Soft Edit—The user enters a Short Sale transaction for UPC-71 Securities

SHORT SALES—SECURITY NOT ELIGIBLE FOR SELLING SHORT REORINIZATION/COMPLIANCE

Hared Edit—OTC Bulletin board and any other securities the firm deems PCG FA's are unable to sell short.

SHORT SALES—PLEASE CALL STOCK LOAN AREA FOR SHARE AVAILABILITY or HARD to BORROW

Hard Edit—This stock has been tagged by the Stock Loan department as a “Hard to Borrow” security. The FA must call the desk in order to sell short.

BUY TO COVER—EXCEEDING SHARES SHORT—

Soft Edit—If the user places a trade for a greater number of shares than they are short in the type 4 account.

BUY TO COVER—NO SHARES OF SECURITY CURRENTLY SHORT IN THE ACCOUNT—The Hard Edit—FA is attempting to place a Buy to Cover trade in Type 4 and there are 0 positions short.

SELL SHORT—PER PHONE ORDERS

Hard Edit—The user is placing a short per phone order.

TYPE 4 ACCOUNT—SELL SHORT & BUY TO COVER

Hard Edit—The user must be blocked from placing a regular Buy or Sell order in a type 4 account. The only valid trades are Sell Short & Buy to Cover.

TYPE 2 ACCOUNT—SELL SHORT & BUY TO COVER

Hard Edit—The user must be blocked from placing a regular Sell Short or Buy to Cover order in a type 4 account. The only valid trades are Buy & Sell.

In the case of a Buy to Cover, the Short amount of the security the user is attempting to cover must=0.

SHORT SALES—ORDER COMBINATIONS

Hard Edit—All order combinations that are specific to short selling must be defined. This includes valid and invalid order instructions.

SHORT SALES—INVALID ORDER TYPE

Hard Edit—The following order types with Short Sales are invalid and should be hard blocked:

Market On Open

Market On Close

On Close

Or Better

With/Without Sale

SHORT SALES—DAY ORDERS ONLY

Hard Edit—The only valid duration for all short sale transactions is a “DAY” Time in Force. Any selection of a Short Sale transaction type should pre-fill a duration field of “DAY” on the front-end. The following duration types with Short Sales are invalid and should be hard blocked:

GTC

GTX

IOC

FOK

### Appendix B

Definitions

Turnaround—indicates that the field defaults to a predetermined entry

Pre-Filled—indicates that the field may be filled in due to the user navigating to the COE interface screen from an integrated interface screen

Mandatory—indicates that the particular field is required before the order may be submitted

Optional—indicates that data for the field does not have to be provided for the order to be submitted.

| Field | Characteristic | Description |
|---|---|---|
| Wire Code | Turnaround | Three character field (alpha/numeric) |
| | | Drop down list contains data based on users' profile. |
| | | Field defaults to the users' primary wire code. (This field may |
| | | be pre-filled.) |
| Account | Mandatory | At least five characters, alpha/numeric account number. |
| | | Drop down list contains account numbers based on users' |
| | | profile. The drop down list contains account number based on |
| | | the users' profile. |
| | | This field may be pre-filled |
| Type | Mandatory | One character field |
| | | Drop down list contains: 1 = cash, 2 = margin 4 = short account. |
| Number of | Mandatory | One character, Numeric only |
| Trades | | The number of trades will establish the number of securities |
| | | for which fields will be provided in subsequent interface screens |
| FA | Mandatory | Four character field |
| | | FA number indicates the financial advisor responsible for the |
| | | trade and to whom the commission is distributed. |
| Transaction | Mandatory | Drop down list contains: Buy, Sell, Buy to Cover, and Sell Short. |
| | | If the user selects “Sell Short” the Duration field will |
| | | dynamically populate with the “Day” field. |
| | | This entry may be pre-filled. |
| Quantity | Mandatory | Maximum five character field, numeric only |
| | | Decimal Places: 0 |
| | | Maximum Quantity: 99999 |
| Symbol | Mandatory | Maximum ten characters field |
| | | Format: WTS, International Securities Format, etc. |
| | | A CUSIP will be displayed if no symbol is available. |
| | | Symbol may be for any type of security, such as a stock, |
| | | option, warrant, futures, etc. |
| | | This entry may be pre-filled. |
| Order Type | Mandatory | Drop down list contains: Market, Limit, Stop, Stop/Limit, |
| | | Market On Open, Markets On Close, Or Better, With or |
| | | Without Sale, and After Hours. |
| | | If the user selects “Market,” “Market on Close,” or “Market |
| | | On Open” the Duration field will dynamically populate with |
| | | the “Day” field. The “Price” and “Qualifiers” fields will also |
| | | be suppressed. |
| Price | Mandatory, | Maximum nine character field, Numeric only |
| | except Market, | Maximum Quantity: 9999.9999 |
| | Market on | Decimal Places: 4 |
| | Open and | |
| | Market on | |
| | Close orders | |
| Stop Price | Mandatory, | Maximum nine character field, Numeric only |
| | only if Stop or | Maximum Quantity: 9999.9999 |
| | Stop Limit is | Decimal Places: 4 |
| | selected in the | This box will be suppressed on the order entry page if any |
| | Order Type | order type is selected other than Stop/Limit. |
| | field | |
| Duration | Mandatory | Drop down list contains: |
| | | DAY: Day Order |
| | | GTC: Good Till Cancel |
| | | GTX: Good Till Cancel |
| | | FOK: Fill or Kill |
| | | IOC: Immediate or Cancel |
| Qualifiers | Optional | Drop down list contains: |
| | | AON: All or None |
| | | DNR: Do Not Reduce |
| | | DNI: Do Not Increase |
| | | AON/DNR: AON/Do Not Reduce |
| | | AON/DNI: AON/Do Not Increase |
| Unsolicited | Mandatory | Drop down list contains: Yes, No |
| Discretion | Mandatory | Drop down list contains: DE, DNE |
| | | Field is displayed only if an account is coded as a Discretion |
| | | Account. This field is suppressed if the account is not coded |
| | | as a “Discretion” account. |
| Commission, | Mandatory | Two Character field |
| Type | | Drop down list contains: TD - Trade Discount, CD - Cents |
| | | per Share, FC - Flat Commission. |
| Rate | Optional | Maximum seven characters, Numeric only |
| | | This field will allow the financial professional to manually |
| | | enter the discount based on the Commission Type field. If the |
| | | user selects FC the field should become blank and support |
| VSP-1, 2, 3 | Optional | Format: (MM/DD/YYYY) |
| | | This field may be pre-filled. |
| | | If the user selects “Buy” or “Sell Short” this field should be |
| | | suppressed. |
| Display | Optional | Drop down list contains: Yes, No |
| | | If the user selects “No,” the customer has requested that |
| | | the order not be displayed and the order is not sent out for |
| | | reflection in the market maker's quote. |
| Destination | Mandatory | Drop down list contains: |
| | | AU: Auto |
| | | NY - New York |
| | | AX - American |
| | | PC - Pacific |
| | | MW - Midwest |
| | | CI - Cincinnati |
| | | PH - Philadelphia |
| | | BS - Boston |
| | | Default to AU |
| | | Access is defined by entitlement and can be suppressed |
| Average | Mandatory | Drop down list contains: Y - Yes, N - No |
| Price: | | Default to No |
| Note to | Optional | Drop down list contains: |
| Trader | | None |
| | | Per Phone |
| | | Wrap Fee |
| | | Settlement Date |
| | | Next Day Settlement |
| | | Cash Settlement |
| | | Default to None |
| Note to | Suppress until | Per Phone - Name of the Trader must be entered or a time |
| Trader | Note to Trader | must be entered. |
| (Input field) | field is selected | Wrap Fee - No Entry Box Needed |
| | | Settlement Date - Date Fields |
| | | Next Date Settlement - No Entry Box Needed |
| | | Cash Settlement - No Entry Box Needed |
| Trailer | Optional | 3 lines of code - 24 characters per line |
| DRIP | Mandatory | Drop down list contains: No, Yes |
| | | Default to No |
| | | This feature replicates an entry requesting participation of the |
| | | individual security into the Dividend Re-investment program |
| Symbol | Function | This button will bring up a symbol lookup function |
| Lookup | | |
| Next | Function | Button will submit order to the system for edits. |
| Reset | Function | Clears contents of information user previously entered. Resets all defaults. |

What is claimed is:

1. A method for facilitating trading of securities over a communications network, comprising:
receiving a navigation request form a user; and
displaying a consolidated order entry interface screen responsive to the navigation request, the consolidated order interface screen providing the user with a single order entry point to submit orders for securities of different types.

2. The method of claim 1, wherein the displayed consolidated order entry interface screen provides the user with a centralized order entry point for a plurality of security trading platforms.

3. The method of claim 2, wherein each of the plurality of security trading platforms processes orders for given types of a securities.

4. The method of claim 2, wherein each of the plurality of security trading platforms processes orders for particular types of security orders.

5. The method of claim 2, wherein each of the plurality of security trading platforms processes orders for particular types of users.

6. The method of claim 2, wherein the consolidated order interface screen provides the user with straight through order processing.

7. The method of claim 6, wherein straight though processing comprises processing orders without order tickets.

8. The method of claim 1, comprising:
displaying a multiple order consolidated order entry interface screen responsive to the navigation request, the multiple order consolidated order entry interface screen providing the user with a single order entry point to submit a plurality of orders for securities of different types.

9. The method of claim 8, wherein the displayed multiple order consolidated order entry interface screen provides the user with a centralized order entry point for a plurality of security trading platforms.

10. The method of claim 8, wherein the displayed the multiple order consolidated order entry interface screen provides the user with a single order entry point for submitting a plurality of orders for securities of different types in one transaction.

11. The method of claim 1, wherein the navigation request is generated from an interface screen integrated with the consolidated order entry interface screen and wherein the consolidated order entry interfaces screen is displayed with relevant form elements filled in.

12. The method of claim 1, comprising:
receiving at least one order to trade securities; and
testing the at least one order to ensure that the at least one order is valid.

13. The method of claim 12, wherein testing the at least one order comprises:
checking the at least one order to determine if syntax edits are required; and
checking the at least one order to determine if business edits are required.

14. The method of claim 13, wherein checking for syntax edits comprises determining whether the at least one order contains requisite information for execution and whether specified information in the at least one order is in a proper format.

15. The method of claim 13, wherein checking for business edits comprises determining whether the at least one order satisfies business rules which define the obligations and limitations for the user.

16. The method of claim 13, wherein checking the at least one order to determine if business edits are required, comprises:
determining if soft edits are required; and
determining if hard edits are required.

17. The method of claim 16, comprising:
associating a soft edit status with the at least one order requiring soft edits;
associating a hard edit status with the at least one order requiring hard edits; and
displaying a recap interface screen comprising a status column wherein the status of the at least one order is displayed.

18. The method of claim 17, comprising confirming at least one order, wherein the at least one order that does not satisfy the soft business rules are able to be posted and wherein the at least one order that does not satisfy the hard business rules are cancelled.

19. The method of claim 12, comprising:
displaying a recap interface screen which allows the user to perform at least one step from the group of steps consisting of: confirm, amend, and cancel.

20. The method of claim 12, comprising:
displaying a short sale authorization interface screen, which allows the user to interactively communicate with a share availability warehouse to determine availability of a particular share for a short sale.

21. The method of claim 12, comprising:
displaying a recap interface screen that indicates whether the at least one order is valid, the recap interface screen allowing the user to perform at least one step from the group of steps consisting of: confirm, amend, and cancel.

22. A method for facilitating trading of securities over a communications network, comprising:
receiving a navigation request form a user;
displaying a consolidated order entry interface screen responsive to the navigation request; and
displaying a multiple order consolidated order entry interface screen responsive to the navigation request,
wherein the consolidated order interface screen provides the user with a single order entry point to submit orders for securities of different types and provide a centralized order entry point for a plurality of security trading platforms, each of the plurality of security trading platforms processing orders.

23. The method of claim 22, comprising:
receiving at least one order to trade securities;
determining whether the at least one order contains requisite information for execution and whether specified information in the at least one order is in a proper format; and
determining whether the at least one order satisfies business rules which define the obligations and limitations for the user.

24. A method of testing at least one order to trade a security, comprising:
determining if soft edits are required;
associating a soft edit status with the at least one order requiring soft edits;
determining if hard edits are required;
associating a hard edit status with the at least one order requiring hard edits; and
displaying a recap interface screen comprising a status column wherein the status of the at least one order is displayed.

25. A system for facilitating trading of securities over a communications network, comprising:
at least one client device having a processor and memory connected to at least one server over the communication network, the client device capable of displaying information received from the at least one server, the at least one server comprising programming logic for displaying a consolidated order entry interface screen responsive to a navigation request, the consolidated order interface screen providing a user with a single order entry point to submit orders for securities of different types.

26. The system of claim 25, wherein the displayed consolidated order entry interface screen provides the user with a centralized order entry point for a plurality of security trading platforms.

27. The system of claim 26, wherein each of the plurality of security trading platforms processes orders for at least one of: given types of a securities, particular types of security orders, or particular types of users.

28. The system of claim 25, wherein the at least one server comprises programming logic for displaying a multiple order consolidated order entry interface screen responsive to the navigation request, the multiple order consolidated order entry interface screen providing a user with a single order entry point to submit a plurality of orders for securities of different types.

29. The system of claim 28, wherein the displayed multiple order consolidated order entry interface screen provides the user with a centralized order entry point for a plurality of security trading platforms.

30. The system of claim 28, wherein the displayed the multiple order consolidated order entry interface screen provides the user with a single order entry point for submitting a plurality of orders for securities of different types in one transaction.

31. The system of claim 25, wherein the at least one server comprises programming logic for testing at least one order received from a user to ensure that the at least one order is valid.

32. The system of claim 31, wherein the at least one server comprises programming logic for testing the at least one order to determine if syntax edits are required and to determine if business edits are required.

33. The system of claim 31, wherein the at least one server comprises programming logic for testing the at least one order to determine if syntax edits are required, determine if soft edits are required, and to determine if hard edits are required.

34. The system of claim 33, wherein the at least one server comprises programming logic for associating a soft edit status with the at least one order requiring soft edits, associating a hard edit status with the at least one order requiring hard edits, and displaying a recap interface screen comprising a status column wherein the status of the at least one order is displayed.

35. The system of claim 34, wherein the at least one server comprises programming logic for confirming at least one order received from the user, wherein the at least one order that does not satisfy the soft business rules are able to be posted and wherein the at least one order that does not satisfy the hard business rules are cancelled.

36. A system for facilitating trading of securities over a communications network, comprising:
at least one client device having a processor and memory connected to at least one consolidated order entry server over the communication network, the client device capable of displaying information received from the at least one server, the at least one server comprising programming logic for:
displaying a consolidated order entry interface screen responsive to the navigation request; and
displaying a multiple order consolidated order entry interface screen responsive to the navigation request, wherein the consolidated order interface screens provide a user with a single order entry point to submit orders for securities of different types and provide a centralized order entry point for a plurality of security trading platforms.

37. A system for testing at least one order to trade a security, comprising:
at least one client device having a processor and memory connected to at least one server over the communication network, the client device capable of displaying information received from the at least one server, the at least one server comprising programming logic for:
determining if soft edits are required;
associating a soft edit status with the at least one order requiring soft edits;
determining if hard edits are required;
associating a hard edit status with the at least one order requiring hard edits; and
displaying a recap interface screen comprising a status column wherein the status of the at least one order is displayed, wherein the at least one order that does not satisfy the soft business rules are able to be posted and wherein the at least one order that does not satisfy the hard business rules are cancelled.

38. A method for facilitating trading of securities over a communications network, comprising:
displaying a short sale authorization interface screen, which allows users to determine the availability of a particular security with a share availability warehouse for a short sale.

39. The method of claim 38, wherein the short sale authorization interface screen comprises at least one form element for specifying security information for which availability will be determined and a conversation form element which enables conversation type messaging between the user and the share availability warehouse.
